(19) United States
(12) Patent Application Publication
(10) Pub. No.: US 2007/0298378 A1
(43) Pub. Date: Dec. 27, 2007

(54) Dental Post Analogs

(75) Inventors: Phillip L. Brown, Draper, UT (US); James C. Broome, Homewood, AL (US); Dan E. Fischer, Sandy, UT (US); Randall Leininger, Sandy, UT (US); Bruce S. McLean, Sandy, UT (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Ultradent Products, Inc., South Jordan, UT (US)

(21) Appl. No.: 11/851,519

(22) Filed: Sep. 7, 2007

Related U.S. Application Data
(63) Continuation of application No. 11/094,991, filed on Mar. 31, 2005, now abandoned.

(51) Int. Cl. A61C 8/00

(52) U.S. Cl. 433/173

(57) ABSTRACT

A dental post analog includes an analog post body, and at least one of means for determining the depth of placement of the distal insertion portion, means for gripping the post body, or means for tethering the post body. The analog post body includes a distal insertion portion and a proximal portion that extends beyond the distal insertion portion. The distal insertion portion is configured for temporary insertion into a recess of a tooth, and at least approximately corresponds to the size, shape, and length of a permanent dental post. The post analog may be radiopaque. It may be disposable or autoclavable.

### CROSS-REFERENCE TO RELATED APPLICATION

The present application is a continuation application of U.S. application Ser. No. 11/094,991 filed Mar. 31, 2005 and entitled “Dental Post Analogs” which is incorporated herein by reference in its entirety.

### BACKGROUND OF THE INVENTION

1. The Field of the Invention

The present invention is in the field of endodontics. More particularly, the invention relates to dental posts, more particularly dental post analogs, used during placement of a crown or other dental prosthetic onto a patient's tooth.

2. The Relevant Technology

When placing a crown or other dental prosthetic onto a person's tooth, the dental practitioner will remove the pulp material forming the nerve of the tooth at issue, carefully prepare the canal that contained the nerve material, and insert a dental post into the canal. The dental post serves to provide support for the core and crown or other dental prosthetic that is finally fitted thereon.

In determining what dental post to install, the dental practitioner considers the length, taper, and size required. Often smaller diameter dental posts are required on the anterior teeth, while larger diameter dental posts are required for the molars. In determining which dental post will provide the best fit, a dental practitioner will often insert a dental post into the prepared canal on a trial basis. If the dental post is too short or too small, a longer or larger post may be inserted until the correct length and size is determined.

With each trial insertion of a dental post, the dental post becomes contaminated by contact with the tissue material within and adjacent to the canal. Each dental post must be discarded or cleaned (e.g., by autoclaving) after being inserted and removed from the canal. Because dental posts can be relatively expensive, discarding them is often not practical. Although cleaning the dental posts is possible, this is often inconvenient and time consuming.

In view of the foregoing, there is an ongoing need for a device that would allow a dental practitioner to determine the characteristics of a correctly sized permanent dental post without requiring insertion and contamination of the permanent dental post.

### BRIEF SUMMARY OF THE PREFERRED EMBODIMENTS

The present invention is directed to a dental post analog. The dental post analog includes an analog post body. The post body includes a distal insertion portion, at least approximately corresponding to the size, shape, and length of a permanent dental post, for temporary insertion into a recess of a tooth. The post body also includes a proximal portion that extends beyond the distal insertion portion. The dental post analog further includes at least one of means for determining the depth of placement of the distal insertion portion, means for gripping the post body, or means for tethering the post body.

According to one embodiment, at least the distal insertion portion of the post body is radiopaque. Providing a dental post analog where at least the distal insertion portion of the post body is radiopaque allows a dental practitioner to more easily view the position of the dental post analog by x-ray or other radiograph.

In an exemplary embodiment, the post body may comprise means for determining the depth of placement of the distal insertion portion. Means for determining the depth of placement of the distal insertion portion may comprise any suitable structure. Examples of suitable structure include: one or more circumferential grooves formed within the distal insertion portion, one or more circumferential ridges formed on the distal insertion portion, or markings formed on the distal insertion portion.

The dental post analog may further comprise means for gripping the post body. An example of means for gripping the post body is a handle formed near a proximal end of the proximal portion of the post body.

The dental post analog may comprise means for tethering the post body. According to one embodiment, means for tethering the post body may comprise a hole formed through the proximal portion of the post body or an optional handle formed on the proximal portion of the post body.

The dental post analog may further comprise coding means for identifying the size of the dental post analog. Such coding means may comprise a number, letter, or other marking on said post body. Alternatively, the coding means may comprise forming at least a portion of the post body so as to be of a selected color.

In some cases it may be desirable for the dental post analog to be provided in a kit. A kit may contain a plurality of dental post analogs as described above. According to one embodiment, the plurality of dental post analogs may initially be interconnected. The kit may contain dental post analogs of varying sizes (e.g., four sizes).

In use, the dental post analogs may be used to determine the size of a permanent dental post to be inserted into a prepared root canal. According to one embodiment, a selected dental post analog is inserted into a prepared tooth recess (e.g., a root canal) on a trial basis to determine whether the inserted dental post analog corresponds in size, girth, and length to a correctly sized permanent dental post. If the dental post analog is too small, the dental post analog may be removed from the tooth recess and replaced with a larger sized dental post analog. Sequentially inserting and removing dental post analogs of varying sizes allows the dental practitioner to determine the correct size, girth, and length of a permanent dental post to be installed.

The dental post analogs may be disposable so as to prevent contamination that would otherwise occur. According to such an embodiment, once the dental post analog has been inserted and removed from a prepared root canal, it may be disposed of. Alternatively, the dental post analogs may be autoclavable. Such an embodiment allows for a dental post analog to be sanitized by heat before reuse, if desired.

According to another method of use, the inventive dental post analogs may be used in forming a burn-out dental prosthetic core. A dental post analog is inserted into a prepared recess of a tooth (e.g., a prepared root canal). A dental prosthetic core is then formed from the tooth recess and dental post analog. The dental prosthetic core may be formed by either a direct technique or an indirect technique, examples of which will be discussed hereinafter.

According to another method of use, the dental post analogs may be used as a temporary or provisional dental post. According to such an embodiment, the dental post analog is inserted into a prepared root canal so as to provide a provisional dental post. Dental post analogs of varying sizes may be installed or may be inserted sequentially in order to determine the correct size. Once the correct sized dental post analog has been determined, a provisional dental prosthetic, for example a core and crown, may be formed and fitted over the inserted provisional dental post to provide a provisional dental restoration. Such a dental restoration may be later removed and replaced with a permanent dental post and a permanent dental prosthetic, when desired.

These and other advantages and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of an exemplary dental post analog;

FIG. 2 is a perspective view of an exemplary kit including a plurality of dental post analogs;

FIGS. 3 and 4 illustrate a method of using a dental post analog as a try-in for a permanent dental post;

FIGS. 5 through 6B illustrate a method of using a dental post analog in forming a burn-out core using a direct technique;

FIGS. 7 through 8B illustrate a method of using a dental post analog in forming a burn-out core using an indirect technique;

FIG. 9 illustrates another method of using a dental post analog in forming a core; and

FIG. 10 illustrates a method of using a dental post analog as a provisional dental post.

### DETAILED DESCRIPTION OF THE PREFERRED EMBODIMENTS

I. Introduction

The invention relates to a dental post analog. The inventive dental post analog includes an analog post body, including a distal insertion portion that at least approximately corresponds in size, shape, and length to a permanent dental post. The post body also includes a proximal portion extending beyond the distal insertion portion. The dental post analog further includes at least one of means for determining the depth of placement of the distal insertion portion, means for gripping the post body, or means for tethering the post body.

II. Exemplary Dental Post Analogs

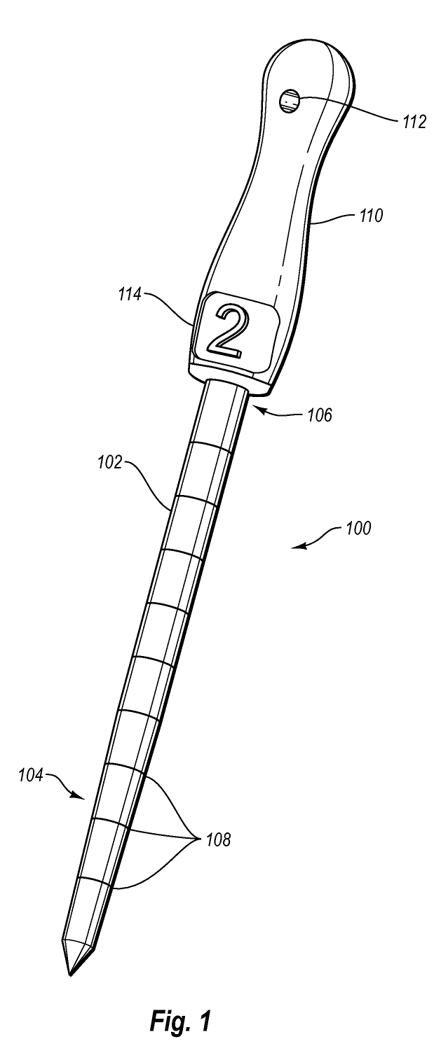

FIG. 1 illustrates an exemplary dental post analog 100. Dental post analog 100 includes an analog post body 102. Post body 102 includes a distal insertion portion 104 and a proximal portion 106 extending beyond the distal insertion portion 104. The distal insertion portion 104 at least approximately corresponds in size, shape, and length to a permanent dental post. Distal insertion portion 104 is configured for temporary insertion into a recess of a tooth.

Analog post body 102 also includes at least one of means for determining the depth of placement of the distal insertion portion, means for gripping the post body, or means for tethering the post body. The illustrated embodiment of dental post analog 100 includes markings 108 formed along distal insertion portion 104. Markings 108 are one example of means for determining the depth of placement of the distal insertion portion. Alternative examples of means for determining the depth of placement of the distal insertion portion include one or more circumferential grooves formed within the distal insertion portion, or one or more circumferential ridges formed within the distal insertion portion.

Dental post analog 100 may include means for gripping analog post body 102. The embodiment illustrated in FIG. 1 includes a handle 110 formed near a proximal end of proximal portion 106 of post body 102. Handle 110 is one example of means for gripping analog post body 102.

Dental post analog 100 may also include means for tethering post body 102. The embodiment illustrated in FIG. 1 includes a hole 112 formed through the proximal portion of handle 110. A string or other flexible leash can be inserted into hole 112 for tethering post body 112 as a safety measure (e.g., to prevent inadvertent swallowing of, or choking on, post body 102). Hole 112 is one example of means for tethering post body 102.

Dental post analog 100 may include coding means for identifying the size of dental post analog 100. Number 114 is one example of means for coding. A letter or other marking may alternatively be used. According to an alternative embodiment, coding means for identifying the size of dental post analog 100 may comprise forming at least a portion of post body 102 so as to be of a selected color (e.g., yellow may signify the smallest size, red and blue may signify or identify intermediate sizes, while green may identify a largest size).

The dental post analogs may be formed from any suitable material. Exemplary materials include, but are not limited to, thermoplastic materials, thermoset materials, ceramics, or metals.

According to one embodiment, at least the distal insertion portion of post body 102 may be formed of a material that is radiopaque. Such an embodiment allows a dental practitioner to see the location of a dental post analog while inserted into a recess of a tooth by x-ray or other radiograph.

In one embodiment, the dental post analog may be disposable. Alternatively, the dental post analogs may be autoclavable so as to allow for reuse.

III. Exemplary Kits

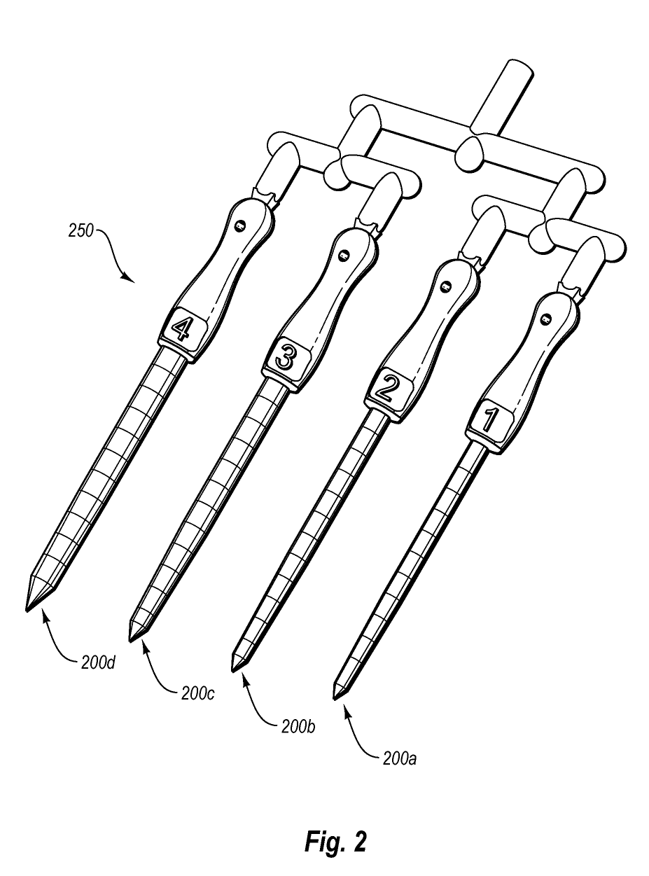

FIG. 2 illustrates a kit 250. Kit 250 includes a plurality of dental post analogs 200a, 200b, 200c, and 200d respectively. Each dental post analog includes an analog post body. The analog post body includes a distal insertion portion, at least approximately corresponding to size, shape, and length of a permanent dental post. The distal insertion portion is configured for temporary insertion into a recess of a tooth. Each analog post body also includes a proximal portion extending beyond the distal insertion portion. Each dental post analog further includes at least one of means for determining the depth of placement of the distal insertion portion, means for gripping the post body, or means for tethering the post body.

As illustrated in FIG. 2, the dental post analogs (e.g. 200a, 200b, 200c, and 200d) of kit 250 may be initially interconnected (e.g., by means of interconnecting structure(s) molded together with the post analogs as a single piece).

According to a further embodiment, kit 250 may include a plurality of dental post analogs (e.g., 200a, 200b, 200c, 200d) including at least one dental post analog of a first size and a different dental post analog of a second size, wherein the first size is different from the second size. The illustrated embodiment includes dental post analogs of four different sizes.

IV. Methods of Using Dental Post Analogs

A. Using a Dental Post Analog as a Try-In

The inventive dental post analogs may be used as a try-in for determining the size of a correctly sized permanent dental post. In this procedure, a dental practitioner selects a dental post analog from a plurality of differently sized dental post analogs. Each dental post analog includes an analog post body including a distal insertion portion and a proximal portion. Each dental post analog further includes at least one of means for determining the depth of placement of the distal insertion portion, means for gripping the post body, or means for tethering the post body. The dental practitioner then determines whether the selected dental post analog of the selected size corresponds in size, girth, and length to a correctly sized permanent dental post relative to a prepared recess of a tooth (e.g., a prepared root canal).

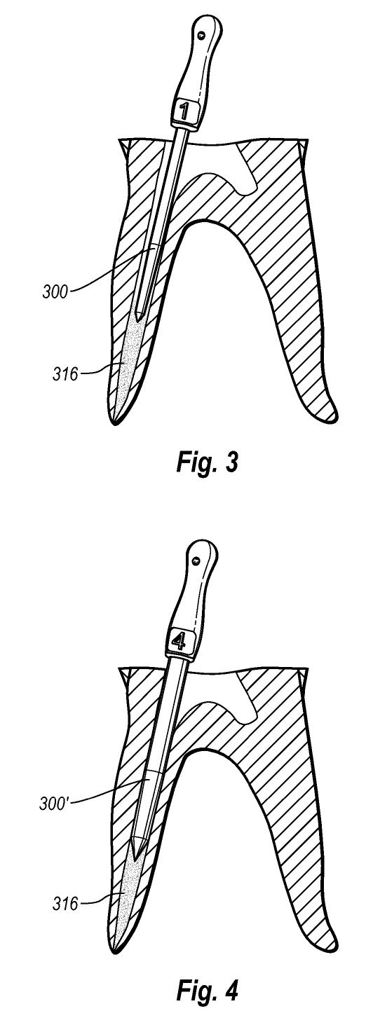

As illustrated in FIGS. 3 and 4, determining whether a dental post analog of a selected size corresponds in size to a correctly sized permanent dental post may be accomplished by inserting the selected dental post analog into a prepared recess of a tooth (e.g., a root canal) on a trial basis to determine whether the inserted dental post analog corresponds in size to a correctly sized permanent dental post. The dental practitioner may continue to insert incrementally larger sized dental post analogs until the correctly sized dental post analog is identified. FIG. 3 illustrates insertion of dental post analog 300 until it contacts packing material (e.g., gutta percha) 316. As can be seen in FIG. 3, dental post analog 300 is too narrow. FIG. 4 illustrates insertion of thicker dental post analog 300′, which is a correct fit for the prepared recess. A permanent dental post corresponding in size, girth, and length to post analog 300′ can then be inserted and bonded into the prepared tooth recess. The removed dental post analog or analogs may be discarded after removal. Alternatively the dental post analogs may be autoclaved or otherwise sterilized so as to allow for reuse.

According to an alternative embodiment, a dental practitioner may determine whether a dental post analog of a selected size corresponds in size to a correctly sized permanent dental post by overlaying the selected dental post analog onto a radiograph (e.g., an x-ray) of a prepared root canal or other tooth recess.
B. Using a Dental Post Analog in Forming a Burn-Out Core

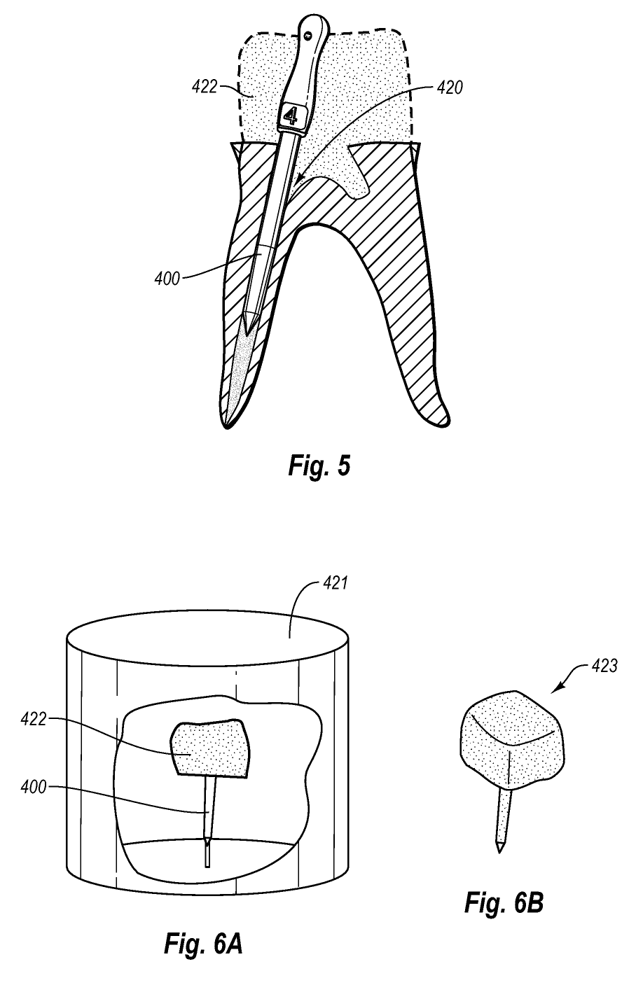

The inventive dental post analogs may be used in forming a burn-out dental prosthetic core. As illustrated in FIG. 5, dental post analog 400 is inserted into a prepared recess of a tooth 420 (e.g., a prepared root canal). A dental prosthetic core may be formed from prepared tooth recess 420 and dental post analog 400. The dental prosthetic core may be formed by either a direct technique or an indirect technique.

According to one embodiment, a dental prosthetic core may be formed by a direct technique. Once dental post analog 400 has been inserted into prepared recess 420, a burn-out modeling material 422 is applied around inserted dental post analog 400 and formed into a desired shape of a dental prosthetic core. The burnout modeling material may be removed once set, along with dental post analog 400 and used to form a permanent dental prosthetic core through a burnout technique. One such burn-out technique is illustrated in FIGS. 6A-6B. The molded material 422 and dental post analog 400 (any “extra” length at the proximal end of post analog 400 may be removed by cutting or breaking, as needed) are embedded within a heat resistant material 421 (e.g., gypsum, clay, or ceramic). The burn-out material 422, including the dental post analog 400, are then melted, burned, or vaporized so as to form a void corresponding to the permanent dental prosthetic core within the heat resistant material. Once the melted burnout material 422 and dental post analog 400 have been completely removed, a molding material (e.g., molten metal or moldable ceramic) is introduced into the void so as to form a permanent dental prosthetic core 423 for bonding within the prepared tooth.

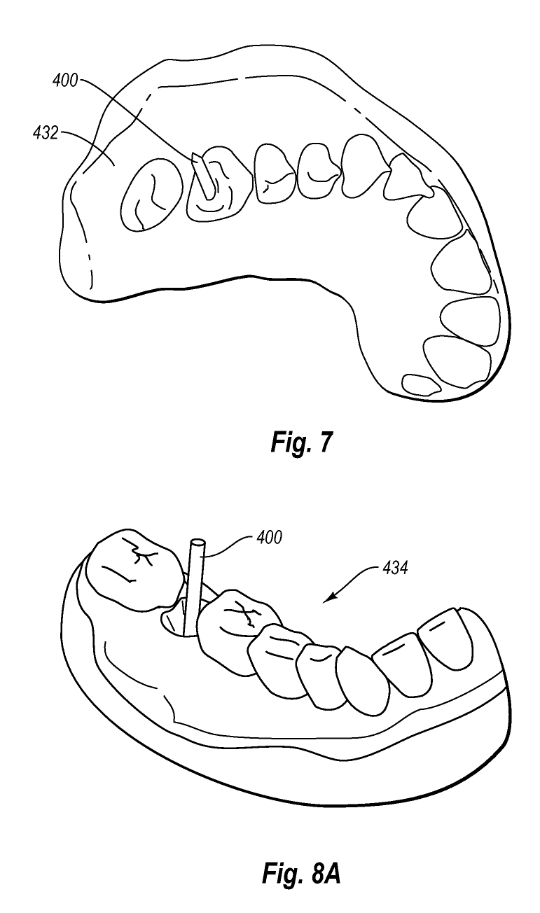

The dental prosthetic core may be formed by an indirect technique as illustrated in FIGS. 7-8B. Once dental post analog 400 has been inserted into prepared tooth recess 420, an impression of the prepared tooth recess and inserted dental post analog 400 is formed with an impression material such that the impression material 432 locks onto inserted dental post analog 400. Impression material 432 and dental post analog 400 are removed from the tooth once the impression material 432 has sufficiently set, as illustrated in FIG. 7. A positive model 434 of the tooth and prepared tooth recess is then formed from the impression, as seen in FIG. 8A. Such positive model may be formed from gypsum plaster or other casting materials know in the art. Once set, a dental post analog 400 is inserted into the prepared tooth recess of the model 434. As illustrated in FIG. 8B, a burnout material 436 may then be applied and formed around the inserted dental post analog 400 so as to form a desired shape of a dental prosthetic core. The modeled burnout material 436 and dental post analog 400 may then be removed and used to form a permanent dental prosthetic core through a burnout technique as described above and illustrated in FIGS. 6A and 6B.
C. Other Methods of Using a Dental Post Analog in Forming a Core

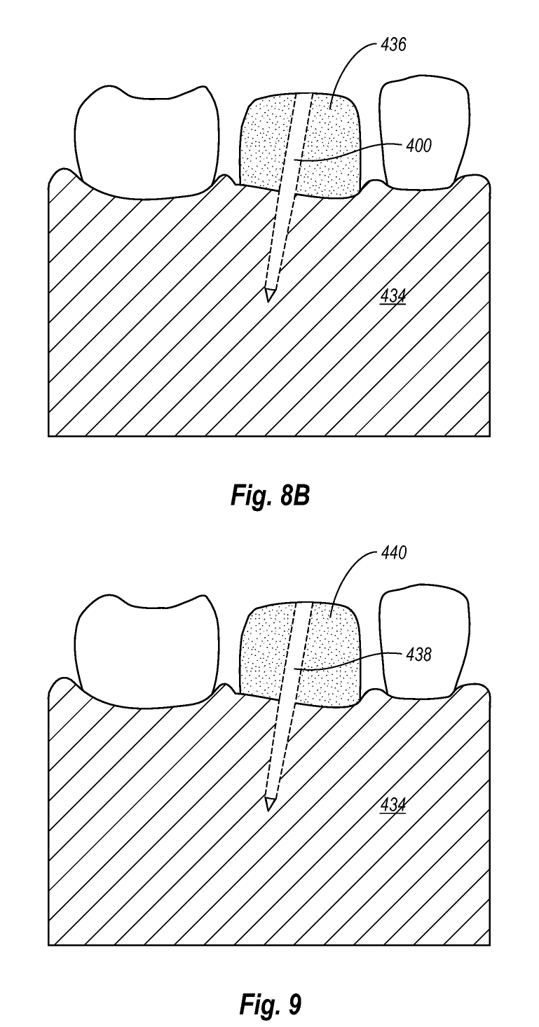

The inventive dental post analog may be used in forming a dental prosthetic core without using a burnout technique. According to one such method, a dental post analog is inserted into a prepared tooth recess as illustrated in conjunction with FIG. 5. An impression of the prepared tooth and dental post analog is formed, and a positive model of the tooth and prepared tooth recess is created once the impression material has set, as illustrated in FIGS. 7 and 8A, respectively. As illustrated in FIG. 9, a permanent dental post 438 may then be inserted into the model 434 of the prepared tooth recess, and a core material 440 (e.g., a curable dental composite) may be applied and formed around inserted permanent dental post 438 into the desired shape of a dental prosthetic core. The core material 440 may then be cured and subsequently bonded into the tooth recess 420. With the use of fast setting impression materials and fast setting casting materials, such a method may be performed chair side in the office of the dental practitioner.

Although some exemplary methods of using the inventive dental post analog in forming dental prosthetics have been described, it is to be understood that other known methods of forming a dental prosthetic can be adapted for use with the inventive dental post analog, and that such methods are within the scope of the invention.
D. Using a Dental Post Analog as a Provisional Dental Post

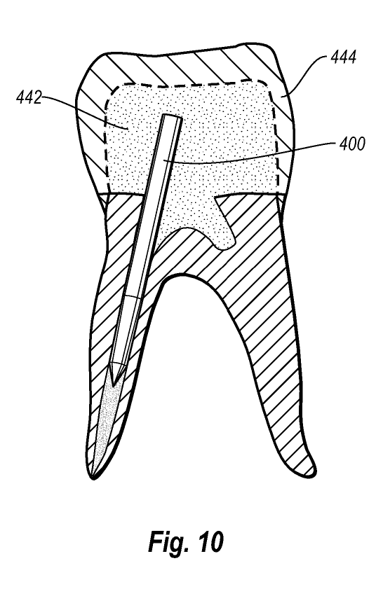

The inventive dental post analogs may be used as a provisional dental post. Using a dental post analog as a provisional dental post may be useful in situations where the prognosis of the tooth is questionable. In such cases a temporary or provisional post and a provisional dental restoration may be accomplished at a relatively low cost as compared to a more expensive, permanent dental restoration. According to one such embodiment, a dental post analog 400 is inserted and bonded into a prepared recess 420 of a tooth so as to provide a provisional dental post as illustrated in FIG. 10. A provisional core 442 may then be formed around inserted dental post analog 400 so as to provide a provisional dental prosthetic core. A provisional crown 444 or other provisional prosthetic may be fitted and bonded as desired. According to one embodiment, the insertion portion of the analog post body is radiopaque so as to allow for easy identification of the provisional dental post in an x-ray or other radiograph. According to one embodiment, it may also be advantageous to bond the dental post analog with a temporary bonding agent or cement so as to allow for subsequent easy removal.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of using a dental post analog as a try-in, comprising:
(a) providing a plurality of dental post analogs, said plurality of dental post analogs including a dental post analog of a first size and a dental post analog of a second size, wherein said first size is different from said second size, each dental post analog comprising:
an analog post body, said post body comprised of:
a distal insertion portion, at least approximately corresponding to the size, shape, and length of a permanent dental post, for temporary insertion into a recess of a tooth; and
a proximal portion, extending beyond said distal insertion portion; and
at least one of means for determining the depth of placement of said distal insertion portion, means for gripping the post body, or means for tethering the post body; and
(b) determining whether a dental post analog of a selected size corresponds in size to a correctly sized permanent dental post relative to a prepared recess of a tooth.

2. A method as recited in claim 1, wherein (b) comprises inserting said dental post analog into a prepared recess of a tooth on a trial basis to determine whether said dental post analog corresponds in size to a correctly sized permanent dental post.

3. A method as recited in claim 2, further comprising removing said dental post analog from the prepared recess of a tooth.

4. A method as recited in claim 3, further comprising discarding said dental post analog after removing it from the prepared recess of a tooth.

5. A method as recited in claim 3, further comprising autoclaving said dental post analog after removing it from the prepared recess of a tooth.

6. A method of using a dental post analog in forming a burn-out dental prosthetic core, comprising:
providing at least one dental post analog according to claim 1;
inserting said dental post analog into a prepared recess of a tooth; and
forming a dental prosthetic core from said prepared tooth recess and said dental post analog.

7. A method as recited in claim 6, wherein said dental prosthetic core is formed by a direct technique, comprising:
forming a burn-out modeling material around said dental post analog in the desired shape of a dental prosthetic core; and
using the formed modeling material to form a dental prosthetic core through a burn-out technique.

8. A method as recited in claim 6, wherein said dental prosthetic core is formed by an indirect technique, comprising:
forming an impression of the prepared tooth and inserting said dental post analog with an impression material such that said impression material locks onto said dental post analog;
removing said impression material and said dental post analog from the tooth once the impression material has sufficiently set;
forming a positive model of the tooth and prepared tooth recess from said set impression material;
inserting a dental post analog into the model of the prepared tooth recess;
forming a burn-out material around the inserted dental post analog in the desired shape of a dental prosthetic core;
using the modeled burn-out material to form a dental prosthetic core through a burn-out technique.

9. A method of using a dental post analog in forming a dental prosthetic core, comprising:
providing at least one dental post analog according to claim 1;
inserting said dental post analog into a prepared recess of a tooth;
forming an impression of the prepared tooth and inserted dental post analog with an impression material such that the impression material locks onto the inserted dental post analog;
removing the impression material and dental post analog from the tooth once the impression material has sufficiently set;
forming a positive model of the tooth and prepared tooth recess from the set impression material;
inserting a permanent dental post into the model of the prepared tooth recess; and
forming a core material around the inserted permanent dental post in the desired shape of a dental prosthetic core.

10. A method as recited in claim 9, wherein said core material comprises a curable dental composite.

11. A method as recited in claim 9, wherein the method is performed chair-side.

12. A method of using a dental post analog as a provisional dental post, comprising:
providing at least one dental post analog, each dental post analog comprising:
an analog post body, the post body comprised of:
a distal insertion portion, at least approximately corresponding to the size, shape, and length of a permanent dental post, for temporary insertion into a recess of a tooth; and
a proximal portion, extending beyond the distal insertion portion; and
at least one of means for determining the depth of placement of the distal insertion portion, means for gripping the post body, or means for tethering the post body;
inserting and bonding said dental post analog into a prepared recess of a tooth so as to provide a provisional dental post; and
forming a provisional core around said inserted dental post analog so as to provide a provisional dental restoration.

13. A method as recited in claim 12, wherein at least said insertion portion of the analog post body is radiopaque so as to allow for easy identification of said provisional dental post.

14. A method as recited in claim 12, wherein said dental post analog is bonded using a temporary cement so as to allow for subsequent easy removal.
